(19) United States
(12) Patent Application Publication
(10) Pub. No.: US 2001/0032028 A1
(43) Pub. Date: Oct. 18, 2001

(54) Virtual disc jockey

(76) Inventors: Anthony S. Volpe, Doylestown, PA (US); Jeffrey M. Glabicki, Philadelphia, PA (US)

Correspondence Address: Jeffrey M. Glabicki, Esquire, Volpe and Koenig, P.C., One Penn Center, Suite 400, 1617 John F. Kennedy Boulevard, Philadelphia, PA, 19103, US

(21) Appl. No.: 09/844,057

(22) Filed: Apr. 27, 2001

Related U.S. Application Data
(60) Provisional application No. 60/200,538, filed on Apr. 27, 2000.

(51) Int. Cl. G06F 17/00

(52) U.S. Cl. 700/94

(57) ABSTRACT

A recorded DJ performance generated on the basis of event-specific information and selected entertainment is provided in a format suitable for broadcast at the event site.

This application claims priority from U.S. Provisional Application No. 60/200,538, filed Apr. 27, 2000.

### BACKGROUND

The invention generally relates to pre-recorded entertainment. More particularly, the present invention relates to pre-recorded audio entertainment for performances at private events.

Disc Jockeys (DJs) regularly perform at different special events, such as wedding receptions, dances and birthday parties. The DJs typically tailor or customize the performance to entertain predetermined guests at these events. These performances typically include playing songs, telling jokes, passing on interesting anecdotes and making event announcements.

Before the event, the client typically gives the DJ a play list and other information concerning the guest's event and any special honoree. Based on this information, the DJ assembles a somewhat customized requested songs list and makes other preparations for the event. Because of this early preparation, travel to the event site, necessary equipment and actual DJ personnel at the event, the cost can become prohibitive for smaller events.

Accordingly, it is desirable to provide an inexpensive means of having the essential features of DJ services at an event without the costs associated with performance.

### SUMMARY

A recorded performance is generated on the basis of event-specific information and selected entertainment is provided in a format suitable for broadcast at the event site.

### BRIEF DESCRIPTION OF THE DRAWING(S)

FIG. 1 is a flow chart of virtual disc jockey.

FIG. 2 is an illustration of a web page for selecting the event for the virtual performance.

FIG. 3 is an illustration of a web page for selecting a song for the bride's and groom's first dance.

FIG. 4 is components used with virtual disc jockey.

FIG. 5 is a performance computer with peripherals.

### DETAILED DESCRIPTION OF THE PREFERRED EMBODIMENT(S)

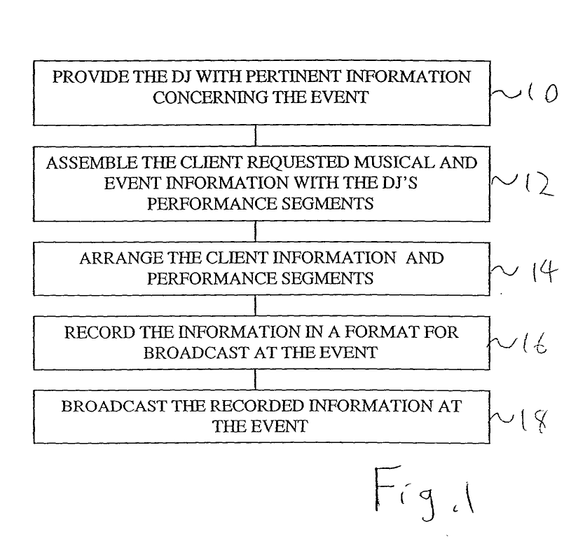

FIG. 1 is a flow chart of virtual DJ. The event client provides the DJ with pertinent information concerning the event, 10, such as a wedding reception, dance or birthday party. This information generally will include a music selection or play list, an itinerary for the event, and guest information, such as stories and idiosyncracies. The present invention is particularly suited to smaller, but still important, events.

One approach to providing the DJ information is for the client to call the DJ by telephone or to meet with the DJ. If the client calls the DJ, information, such as a guest list, itinerary, anecdotes and a song play list, may be sent to the DJ by email, express mail or conventional mail. If the client meets with the DJ, that information may be handed to the DJ or sent at a later date.

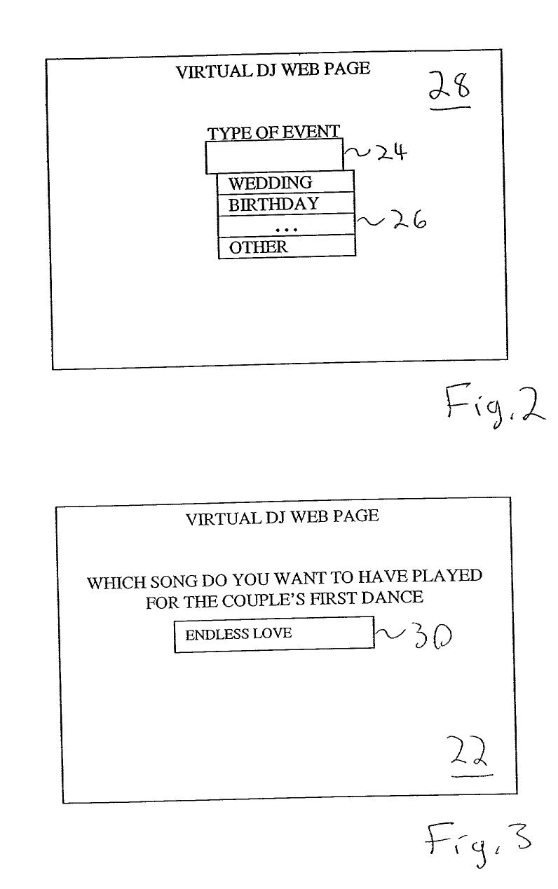

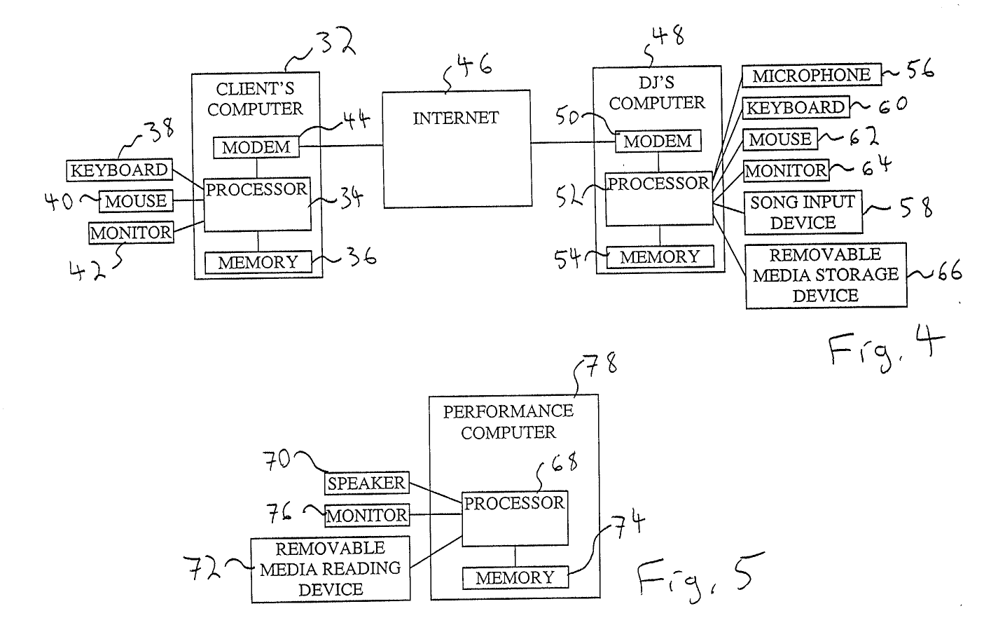

Another approach to providing the DJ information is via a web site. Illustrations of pages 22, 28 from such a web site are shown in FIGS. 2 and 3. To establish an Internet connection, the client's computer 32, as shown in FIG. 4, will access the Internet by a modem 44. After making appropriate inputs using the keyboard 38 and mouse 40, a page 28 from the DJ's web site, such as illustrated in FIG. 2, will be shown to the client. The web page 28 has a field 24 for inputting the type of event, such as wedding reception or dance. Using the mouse 40 and keyboard 38, the client will input the event into the field 24. To reduce the input time, a pull down menu 26 may be used to select the event. If the event is not on the menu 26, the client selects “other” which will provide a field for the event to be inputted via keyboard 38.

Based on the selected event, other pages 22 will be displayed. These pages 22 will request the appropriate information for the event. For a wedding, the pages 22 may request which song will be performed for each sub-event at the wedding. As shown in FIG. 3, the client will input to field 30 which song to perform at the couples' first dance, such as “Endless Love”. If the client wishes to leave certain song selections to the DJ's discretion, “DJ's choice” is input to the field 30. If the sub-event will not be at the event, “NA” is input. Information inputted through the web pages 22, 28 is sent to the DJ's computer 48 through its modem 50 and processor 52 for display on a monitor 64.

Since the song selections may be lengthy, alternately, they may be sent to the DJ by email, express mail or conventional mail. Other event information is typically too voluminous to be sent through a web page 22, 28, such as a guest list, itinerary and anecdotes. This information is sent to the DJ, such as by email, express mail or conventional mail.

After the DJ is provided the pertinent information concerning the event, the DJ will assemble the client requested musical and event information. If the guest desires to leave certain song selections to the DJ's discretion, such as dance songs, the DJ will select appropriate songs.

Based on the itinerary for the event, the DJ, using a microphone 56 operatively coupled to a processor 52 of the DJ's computer 48, will record segments of the DJ's performance. These segments may include announcements, jokes and anecdotes. The DJ will also record or download the assembled songs through a song input device 58, such as a compact disc (CD) player or CD read only memory (CD-ROM), 12. Alternately, the songs may be stored in a memory 54 associated with the processor 52 in an electronic format, such as MP3. The songs may also be downloaded from other sources, such as through a commercial site on the Internet 46, using the modem 50.

The client information and performance segments will be arranged by the DJ using the mouse 62 and keyboard 64, 14. The DJ views the arrangement using monitor 64. The arrangement will be based on the itinerary provided by the client. The resulting arrangement will be a recording of the DJ's virtual performance at the event.

Alternately, the arrangement may be prepared on a real time basis. Based on the itinerary, the DJ will perform and interject songs as if the DJ was at the event. The DJ will speak into the microphone 56 and songs will be added through the song input device 58. The entire virtual performance is stored in a memory 54 associated with the processor 52.

After the virtual performance is recorded, it is formatted for broadcast at the event, 16. The formatted data is subsequently transferred to the client. One preferred transfer approach is the use of a storage device 66, such as a CD recording device, to store the virtual performance on a CD or series of CDs.

To prevent the CD from being used for other performances, the DJ may secure return of the CDs by use of a security deposit, such as by cash, credit card deposit or keeping a driver's license. Alternately, at events, such as a wedding, where the client may wish to save the CD as a memento, the DJ may charge an additional premium for the CDs. Based on the composition of the virtual performance, appropriate licenses from the songs' owners may need to be obtained.

At the event, the client places the CD in a CD player. At the appropriate time, the client starts the virtual performance by pressing “play” on the CD player, 18. As a result, the event's attendees will be able to enjoy the virtual DJ's performance.

Alternately, the entire performance may be recorded into other electronic formats, such as MP3 or a wave file. These alternate formats may be sent to the client via a modem 50 through the Internet 46 or an attachment to an email. Alternately, the virtual performance may be stored on removable media, such as a CD-ROM, using a removable media storage device 66. The removable media is sent to the client, such as by conventional or express mail.

Using the other electronic formats, the DJ may include additional precautions to prevent reuse of the performance. The DJ may insert a “time bomb” into the recorded data to prevent reuse of the virtual performance. Another advantage of some electronic formats, such as MPEG-4, is that the DJ will be able to add visual effects to the performance. The visual effects may include a display of pictures provided by the client. To illustrate, for a 50th wedding anniversary, a slide show of pictures from the wedding could be displayed. The visual effects may also include video, such as from home movies.

After the client receives the virtual performance in one of the other electronic formats, the client uses a performance computer 78, as shown in FIG. 5, to entertain the guests. Based on the capabilities of the client's computer 32, these two computers may be the same. Depending on the format of the sent virtual performance, the performance computer 66 will have either a removable media reading device 72 to read the electronic recording or the virtual performance will be stored in a memory 74 associated with the processor 68. The processor 68 will send signals to speaker 70 where the audible performance is generated, 18. If visual effects were also included in the performance, the visual portion of the performance is displayed on monitor 76.

What is claimed is:

1. A virtual DJ comprising:
a recording media selected for broadcast at a predetermined event;
a selection of event specific material fixed on the recording media; and
DJ performance materials complementary arranged and fixed on the recording media with the event specific material.

2. The virtual DJ of claim 1 wherein the recording media is an audio media.

3. The virtual DJ of claim 1 wherein the recording media is audio and visual.

4. The virtual DJ of claim 1 wherein the recording media has a predetermined life span.

5. The virtual DJ of claim 1 wherein the recording media is a compact disc.

6. The virtual DJ of claim 1 wherein the recording media is a compact disc read only memory.

7. The virtual DJ of claim 3 wherein the recording media includes pictures for display at the predetermined event.

8. The virtual DJ of claim 3 wherein the recording media includes a slide show for display at the predetermined event.

9. The virtual DJ of claim 1 wherein the recording media includes songs from a play list.

10. The virtual DJ of claim 1 wherein the event specific material includes guest information.

11. The virtual DJ of claim 1 wherein the recording media includes software to enable a display of visual effects synchronized with audio portions of the DJ performance materials.

12. A method for performing recorded material at a predetermined event, the method comprising:
gathering event specific material associated with the predetermined event;
producing a recorded performance by complementarily arranging a DJ's performance material with the gathered material and event specific material; and
playing the recorded performance at the predetermined event.

13. The method of claim 12 wherein the gathering of event specific material is in response to a play list and guest information.

14. The method of claim 13 wherein the guest information includes stories and idiosyncracies.

15. The method of claim 12 wherein the complementary arrangement of the recorded performance is based on in part an event itinerary.

16. The method of claim 12 further comprising an event client providing pertinent information regarding the predetermined event.

17. The method of claim 12 further comprising providing an event client the recorded performance in a recording media.

18. The method of claim 17 wherein the recording media has a predetermined life span.

19. The method of claim 17 further comprising accepting a security deposit from the event client prior to the step of providing.

20. A virtual DJ system comprising:
means for gathering event specific material associated with the predetermined event;
means for producing a recorded performance by complementarily arranging DJ performance material with the gathered material and event specific material; and
means for playing the recorded performance at the predetermined event.

21. The virtual DJ system of claim 20 wherein said gathering means includes an Internet web site having an input configured to receive event specific material provided by an event client.

22. The virtual DJ system of claim 20 wherein the playing means includes a computer.

23. A recording media for broadcast at a predetermined event, material fixed on the media comprises:
a selection of event specific material for the predetermined event; and
DJ performance materials complementarily arranged with the event specific material.

24. The recordable media of claim 23 wherein the fixed material further comprising a time bomb to prevent use of the recording media after the predetermined event.
